(19) United States
(12) Patent Application Publication
(10) Pub. No.: US 2005/0110302 A1
(43) Pub. Date: May 26, 2005

(54) Integrated steel cross-car beam

(76) Inventors: Keith A. Riha, Rochester, MI (US); Colin Newport, Ontario (CA); Ulrich Weissert, Rochester, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/821,675

(22) Filed: Apr. 9, 2004

Related U.S. Application Data
(63) Continuation of application No. PCT/US02/32638, filed on Oct. 11, 2002.
(60) Provisional application No. 60/328,628, filed on Oct. 11, 2001.

(51) Int. Cl. B62D 25/08

(52) U.S. Cl. 296/193.02

(57) ABSTRACT

A metal cross-car beam for support of components in a vehicle comprises a hollow metal tube of unitary construction including end sections, said tube formed to accommodate direct attachment of vehicle components at various points to said tube, wherein said end sections are formed into flanges which attach directly to a vehicle body.

### CROSS REFERENCE TO RELATED APPLICATIONS

This application is a continuation of International Application No. PCT/US02/32638 filed Oct. 11, 2002 and published Apr. 17, 2003 as International Publication No. WO 03/031746, designating the United States, and which claims benefit of U.S. Provisional Application No. 60/328,628 filed Oct. 11, 2001.

This invention relates to a metal cross-car beam used in the cockpit of a vehicle to support the instrument panel, steering column, pedals, air bag canister and related compartments and to manage energy in vehicle impact events. More particularly, the metal beam is constructed of a steel or aluminum tube with a closed cross-section having formed ends for attachment to the car body, eliminating bracketry and reducing cost. The ends of the beam may be formed by stretching and flattening the tubing wall thus providing a larger attachment surface resulting in better load distribution and increased stiffness and stability.

### BACKGROUND OF THE INVENTION

Cross-car beams which support instrument panel components and absorb energy in vehicle impact events are generally complex assemblies made up of three general sections, 1) driver's side (with steering column bracket), 2) passenger side with air bag canister support and 3) center console (often supporting an HVAC unit). In addition, while this beam can be provided in one or more sections, connections to the A pillars (or front side pillars) require the use of brackets since the closed shape of the beam is required for stiffness while the ends need to be of a flat shape for attachment. A number of references address such bracketry.

In U.S. Pat. No. 5,238,286 to Mazda, a support beam 1 having a hollow internal reinforcing pipe 11 is disclosed. It is attached at the pillar areas by brackets 12.

U.S. Pat. No. 5,934,733, to GM discloses an extruded cross-car beam that uses end caps 3, 4 to attach to the A pillars.

U.S. Pat. No. 5,230,530 to Mazda discloses a generally round steering support member 26 connected to the hinge pillars by brackets 27.

U.S. Pat. No. 5,868,426 to Chrysler discloses a cross beam mounted in a vehicle body between cowls on opposite sides of the vehicle to support a steering column. Brackets 32, 33 are used to affix the beam 30 to the cowls.

There are numerous other references in the art of composite beams formed to provide structural stiffness and to support vehicle components which have end features readily attachable to the vehicle pillar areas. However, what is needed is a single piece cross-car support made of metal that has end features integrally formed which are readily and directly attachable to vehicle pillar areas.

### SUMMARY OF THE INVENTION

A metal cross-car beam for support of components in a vehicle comprises a hollow metal tube including end sections, said tube formed to accommodate direct attachment of vehicle components at various points to said tube, wherein said end sections are formed into flanges which attach directly to a vehicle body.

### BRIEF DESCRIPTION OF THE DRAWINGS

These and other objects, features and advantages of the invention will become apparent upon consideration of the description of this invention and the appended drawing in which:

FIG. 1 shows a perspective view of the cross-car beam of the invention.

### DESCRIPTION OF THE PREFERRED EMBODIMENT

A metal cross-car beam for structural support of components and energy management in the cockpit of a vehicle is preferably produced from a steel tube of generally square, closed cross-section shape which is formed to accommodate both component attachment and attachment to the vehicle. Preferably through the process of hydro-forming, the driver's side end of the tube can be expanded and tailored in shape to improve the section properties of the beam and to provide a mounting surface for the steering column. Since the cross-sectional shape is preferably square on the passenger's side of the beam, the air bag canister can be readily attached directly to it. Finally, and preferably through a pinching operation, the ends of the square tube are expanded, then flattened to accommodate bolts to attach the beam directly to the A-pillar and cowl areas of the vehicle. Each end of the flattened tube may have a different thickness, if desired, to add structural integrity for attachment or to reduce weight. This beam construction eliminates the need for additional attachment bracketry, resulting in a single piece beam that minimizes assembly labor.

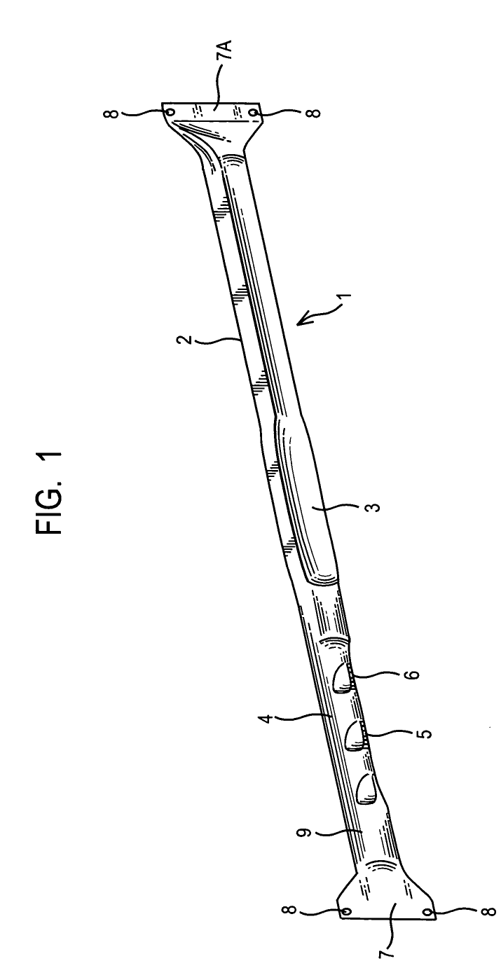

FIG. 1 shows a preferred 3.5 inch by 3.5 inch hollow steel tube formed into a cross-car beam 1 having features formed for the attachment of components as well as features formed for attachment of the beam to the vehicle body. In the context of the present invention, tube cross-section can vary between 1.0 inch by 1.0 inch to 7.0 inch by 7.0 inch, in increments of 0.001 inches, and the shape can vary, but is not limited to, e.g. square, rectangular, round, hexagonal, trapezoidal, etc.

To produce the cross-car beam of the present invention, it is preferred to use a hydroforming process and a steel, steel alloy, aluminum or aluminum alloy relatively thin-wall hollow tube. The process may preferably comprise a set of dies or molds having cavities in the configuration of the final shape of the cross-car beam. These dies are generally held in a conventional single action hydraulic press having high ram force. The metal tube is rolled or formed, and welded into a regular shape that is placed into the dies. After the dies are closed, fluid pressure is applied, generally in stages to the inside of the tube to expand the tube to conform to the configuration of the cavities of the dies. The beams thus formed have many advantages over welded sheet metal parts including reduced manufacturing costs by decreasing part count, and improved performance by reducing mass and increasing stiffness.

The generally square hollow tube is formed to receive an airbag canister directly attached on the passenger side 2 eliminating the need for additional bracketing. In the center 3 of the beam 1, the cross-section is flattened somewhat to accommodate brackets attached to the instrument panel and to attach to the glove box and center stack areas for stability and support. In the steering column area 4 on the driver's side of the cross-car beam, a large triangular 5.25 inch section is formed as one surface for direct attachment of the steering column to the beam 1. Attachment features to accept the steering column assembly are shown at 5, 6. Likewise, the pedal system for the vehicle may be directly mounted to the beam 1 in this same area. It is also preferred to form the beam 1 by stretching or compressing the cross-section of the hollow tube to allow for a thicker gage on the driver's side end 7 (preferably about 2.5 mm) for higher structural integrity while allowing for a lower gage (preferably 1.5 mm) on the passenger's side end 7A to save weight. Of particular note is the round cross-section formed at 9 on the driver's side end of the beam to provide additional strength for support of the steering column and pedal arrangement. The ends of the tube 7, 7A are formed by expanding the diameter of the tube, preferably by as much as 50%, then pinching the ends together to create a flat attachment flange. Holes 8 in this flange allow direct attachment of the beam 1 to the vehicle body in the A pillar area without additional brackets being required. The length of the tube extends from 7 to 7A in FIG. 1.

Thus, it can be seen that the invention provides a new and improved single piece metal cross-car beam which can be formed into various shapes along its length to accommodate attachment of components and to support numerous vehicle components. Further this single unitary piece cross-car beam may have attachment flanges formed integrally for direct attachment to the vehicle body, eliminating numerous attachment brackets and saving cost, weight and assembly labor.

The description and drawings illustratively set forth the presently preferred invention embodiments. The description and drawings are intended to describe these embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise than as the description and drawings specifically shown and described.

1. A metal cross-car beam of unitary construction for support of components in a vehicle comprising:
a hollow metal tube including end sections, said tube formed to accommodate direct attachment of vehicle components at various points to said tube, wherein
said end sections are formed into flanges.

2. The metal cross-car beam of claim 1, wherein said hollow tube contains a length and a cross-sectional shape which varies along said length.

3. The hollow metal tube in claim 1, having a thickness wherein the thickness of said hollow metal tube varies along said length of said beam.

4. The cross-car beam of claim 1, wherein the hollow metal tube is steel or alloys thereof.

5. The cross-car beam of claim 1, wherein the hollow metal tube is aluminum or alloys thereof.

6. The cross-car beam of claim 1, wherein said tube is formed by hydroforming.

7. The cross-car beam of claim 2, wherein said tube cross-sectional shape is varied by stretching or compressing the tube.
